(19) United States
(12) Patent Application Publication
(10) Pub. No.: US 2007/0131795 A1
(43) Pub. Date: Jun. 14, 2007

(54) Device and method for mixing and dispensing fluid components of a multicomponent composition

(76) Inventors: Anthony J. Abbate, Santa Clara, CA (US); Phu Phung, Union City, CA (US); Robert A. Dutchik, San Diego, CA (US)

Correspondence Address: MINTZ, LEVIN, COHN, FERRIS, GLOVSKY AND POPEO, P.C, 1400 PAGE MILL ROAD, PALO ALTO, CA, 94304-1124, US

(21) Appl. No.: 10/578,545

(22) PCT Filed: Nov. 8, 2004
(86) PCT No.: PCT/US04/37450

§ 371 Date: Jan. 25, 2007

Related U.S. Application Data
(60) Provisional application No. 60/518,379, filed on Nov. 7, 2003.

(51) Int. Cl. B05B 7/10

(52) U.S. Cl. 239/400; 239/399

(57) ABSTRACT

Provided are devices and methods for dispensing a multicomponent composition comprised of a mixture of a plurality of different fluid components. A diffuser surface is placed downstream from a plurality of inlets. An outlet extends through the diffuser surface. At least one inlet placed in fluid communication with a source of a pressurized carrier fluid, and each of a plurality of inlets is placed in fluid communication with a source of a different fluid component. Once the diffuser surface receives fluid components, each received fluid component is directed toward the outlet for mixing and dispensing therethrough by the pressurized carrier fluid from the carrier fluid inlet. Typically, the fluid components are maintained in a different flow path on the diffuser surface before mixing.

### CROSS-REFERENCE TO RELATED APPLICATIONS

This application claims priority under 35 U.S.C. § 371 to PCT/US2004/037450 filed on Nov. 8, 2004, which claims priority under 35 U.S.C. § 119(e) to U.S. Provisional Application No. 60/518,379 filed on Nov. 7, 2003, all which are incorporated by reference in their entireties herein.

### TECHNICAL FIELD

The present invention generally relates to devices and methods for dispensing a multicomponent composition comprised of a mixture of a plurality of different fluid components. More particularly, the invention relates to devices and methods that employ a diffuser surface to direct the fluid components toward an outlet for mixing and dispensing therethrough.

### BACKGROUND ART

Surgical adhesives are used in addition or as an alternative to fastening means such as sutures or staples to join a plurality of tissue surfaces. For example, biologically and non-biologically based surgical adhesives may be formed by mixing two reactive fluid components. Once the components react with each other, a network may be formed. Depending on the chemistry of the particular adhesive, reaction time may occur quickly, e.g., on the order of seconds. Quick reactions limit the time available for application of the adhesive to a target tissue site. In addition, partial mixing may result in the formation of weak spots. Thus, it is desirable to minimize the amount of time required to mix the fluid components together thoroughly prior to delivery to the target site.

Numerous technologies are known for mixing and dispensing multicomponent compositions. For example, U.S. Pat. No. 6,102,256 to Gueret is directed to a dispensing assembly useful for dispensing cosmetic products. In addition, U.S. Pat. No. 3,884,388 to Holcomb is directed to a mixing device for a beverage dispenser. U.S. Pat. No. 3,159,312 to Van Sciver is directed to a dispensing device for mixing fluids such as a plastic and a hardener. Additional examples of mixing and dispensing technologies are described in U.S. Pat. Nos. 1,232,510, 2,653,733, 2,819,723, 3,117,696, 3,145,877, 3,168,967, 3,200,995, 3,236,418, 3,236,457 and 3,884,388.

Similarly, in the context of surgical adhesives, numerous mixing and dispensing technologies are available. For example, a first fluid component of a surgical adhesive may be applied directly onto a target site, followed by the application of a second fluid component onto the first fluid component layer. Once dispensed, the two fluid components may be mixed using a surgical instrument and spread over the target area. Alternatively, the two fluid components may be premixed and applied to the target site. For example, U.S. Pat. No. 6,132,396 to Antanavich et al. describes a manifold for combining first and second components of a sealant. Two cylindrical compartments are provided for separately containing the fluid components of the sealant. The cylindrical compartments are arranged such that the components are merged when the components are simultaneously displaced from the respective compartments within an outer sleeve housing an inner needle. As another example, U.S. Patent Application Publication No. 2002/0138038 to Ljungquist describes a multichannel device for dispensing at least two mutually reactive components such as fibrinogen and thrombin. Optionally, pressurized gas may be used to effect fluid component delivery. See, e.g., U.S. Pat. No. 5,722,950 to Fujita et al.

In addition, a number of patents describe devices that bring fluid components together for mixing and that apply the mixed adhesive in either an aerosol or a stream form to a target site. In some instances, a device may separately atomize the fluids outside the device for contact, mixing, and deposition on the target site. For example, U.S. Pat. No. 5,989,215 to Demotte et al. describes a medical device for laparoscopically delivering volumetric quantities of a first and a second biochemically reactive fluid. First and second containers, each having a fluid opening and containing an appropriate biochemically reactive fluid, are provided. Also provided is a means for separately atomizing the fluids into an aerosol. A fluid pressurizer serves to pressurize the fluids for delivery through a spray unit onto a surface. As a result, the fluids mix on the surface.

Similarly, U.S. Pat. No. 6,165,201 to Sawhney et al. describes an apparatus for forming a tissue adherent coating from first and second solutions. First and second chambers are provided for storing the first and second solutions, while a third chamber is coupled to a source of pressurized gas. First and second nozzles are coupled to first and second supply lines, respectively, which, in turn, fluidly communicate with the first and second chambers, respectively. An opening is provided communication with the third chamber. Pressurized gas entering the third chamber enters the first and second supply lines and propels the first and second solutions out of the first and second nozzles, respectively, to atomize and mix the first solution with the second solution.

Alternatively, fluid components may be mixed within a device. However, when components are mixed within the device, clogging may occur. For example, U.S. Pat. No. 5,887,755 to Hood describes a preparation and application device useful for mixing and dispensing a plurality of fluids, wherein the fluids are mixed immediately prior to use. The device includes two fluid delivery systems connected to a manifold having two separate fluid channels. Each fluid channel conducts fluid to a mixing chamber, from which, following mixing, the mixture of fluids is dispensed. The manifold additionally includes a gas channel having an outlet connected to one of the fluid channels, which can be used to supply a pressurized gas to the mixing chamber to expel the mixture from the chamber. The gas channel terminates at an outlet that is continuous with a wall of the fluid channel connected thereto. Because the gas channel does not extend to the outlet end of the manifold, the likelihood that the mixture can clog the device is reportedly reduced.

Nevertheless, devices such as those described in Hood suffer from a number of disadvantages. For example, because the fluids are mixed in the mixing chamber, residue from the mixture may accumulate in the mixing chamber. Accumulation of such residue over time tends to result in clogging of the device. Thus, there is a need to overcome the disadvantages associated with previously known devices for dispensing a multicomponent composition comprised of a mixture of a plurality of different and typically reactive fluid components.

### SUMMARY OF THE INVENTION

Accordingly, it is an object of the present invention to overcome the above-mentioned disadvantages of the prior art by providing device and methods that employ a diffuser surface to direct fluid components of a multicomponent composition toward an outlet for mixing and dispensing therethrough.

Additional objects, advantages, and novel features of the invention will be set forth in part in the description that follows, and in part will become apparent to those skilled in the art upon examination of the following, or may be learned through routine experimentation upon practice of the invention.

In one embodiment, the invention relates to a device for dispensing a multicomponent composition comprised of a mixture of a plurality of different fluid components. The device includes a plurality of inlets, a diffuser surface located downstream from the inlets and an outlet extending through the diffuser surface. While at least one inlet is adapted to communicate with a source of a pressurized carrier fluid, each of a plurality of inlets is adapted to communicate with a source of a different fluid component. The diffuser surface is adapted to receive fluid components thereon, and has a shape effective to direct each received fluid component toward the outlet for mixing and dispensing therethrough by the pressurized carrier fluid from the carrier fluid inlet. Typically, the fluid components are maintained in different flow paths on the diffuser surface before mixing.

In addition, the components of the inventive device, e.g., the inlets and the diffuser surface, may be immobilized with respect to each other, e.g., assembled to form a nozzle. In some instances, the inlets are each located at the terminus of a corresponding lumen that coextend through a solid tubing member. Optionally, a plurality of carrier fluid inlets is provided to communicate with a source of pressurized carrier fluid, wherein the carrier fluid inlets define a line that is perpendicular to a line defined by the fluid component inlets. In such a case, a slot-shaped orifice may be located at the center of the diffuser surface in alignment with the carrier fluid inlets to serve as the outlet. Preferably, the diffuser surface exhibits axial and/or mirror symmetry and is not detachable from the inlets.

In another embodiment, the invention provides a method for forming the above-described device. The method involves placing a diffuser surface as described above downstream from a plurality of fluid component inlets and at least one carrier fluid inlet. A different fluid component from each of the fluid component inlets may be directed at substantially the same or different flow rates toward the diffuser surface. In addition, pressurized carrier fluid is directed from the at least one carrier fluid inlet through the outlet. As a result, fluid components present are mixed at the outlet, and the composition formed from the mixture is dispensed through the outlet.

Typically, the pressurized carrier fluid is a gas and is chemically inert with respect to the fluid components. In addition, at least one fluid component may be a liquid, and the fluid components may be chemically reactive with respect to each other. For example, at least one fluid component may be comprised of a crosslinking agent. In addition, the fluid components may be comprised of a synthetic compound, such as a polyethylene glycol-containing compound or a naturally occurring compound, such as a protein or a saccharide. Once mixed, a biocompatible composition such as a biocompatible adhesive or adhesion inhibitor may be formed.

### BRIEF DESCRIPTION OF THE DRAWINGS

FIGS. 1 and 2 schematically illustrate an embodiment of the inventive device that includes a cap having an interior diffuser surface and a lumen assembly for delivering fluid components and a pressurized carrier fluid to the diffuser surface. FIG. 1 depicts the device in exploded view and FIG. 2 depicts the interior diffuser surface of the cap.

### DETAILED DESCRIPTION OF THE INVENTION

Before the invention is described in detail, it is to be understood that unless otherwise indicated this invention is not limited to any particular materials, components, or manufacturing processes, as such may vary. It is also to be understood that the terminology used herein is for purposes of describing particular embodiments only, and is not intended to be limiting.

It must be noted that, as used in the specification and the appended claims, the singular forms “a,” “an”, and “the” include plural referents unless the context clearly dictates otherwise. Thus, for example, reference to “an inlet” includes a single inlet as well as two or more inlets, “a lumen” includes a single lumen as well as two or more lumens, and “a polymer” may encompass one or more polymers, and the like.

In this specification and in the claims that follow, reference will be made to a number of terms that shall be defined to have the following meanings unless the context clearly indicates otherwise.

The term “adhesive” is used in its ordinary sense and refers a material that promotes the physical attraction or joining, e.g., on a macroscopically observable scale, of two or more substances, e.g., animal or human tissue. Accordingly, the term “adhesion inhibitor” refers to a material that hinders adhesion between two or more substances.

The term “biocompatible” refers to the ability of the compositions of the present invention to be applied to tissues without eliciting significant inflammation, fibrosis, or tissue responses that are toxic, injurious or otherwise adverse.

The term “collagenic material” as used herein refers to all forms of collagen, including those that have been recombinantly produced, extracted, processed, or otherwise modified. Preferred collagens are non-immunogenic and, if extracted from animals, are treated to remove the immunogenic telopeptide regions (“atelopeptide collagen”), are soluble, and may be in the fibrillar or non-fibrillar form. Collagen used in connection with the preferred embodiments of the invention is in a pharmaceutically pure form such that it can be incorporated into a human body for the intended purpose. Additional information relating to collagenic materials is provided below.

The term “conjugated” is used herein to refer to attached through a chemical bond, typically a covalent bond.

The term “fluid” as used herein refers to matter that is nonsolid or at least partially gaseous and/or liquid. A fluid may contain a solid that is minimally, partially or fully solvated dispersed or suspended. Examples of fluids include, without limitation, aqueous liquids (including water per se and salt water) and nonaqueous liquids such as organic solvents and the like.

Optional” or “optionally” means that the subsequently described circumstance may or may not occur, so that the description includes instances where the circumstance occurs and instances where it does not.

The term “polymer” refers to a molecule consisting of individual chemical moieties, which may be the same or different, but are preferably the same, that are joined together. As used herein, the term “polymer” refers to individual chemical moieties that are joined end-to-end to form a linear molecule, as well as individual chemical moieties joined together in the form of a branched structure.

The term “resorbable” is used herein in its ordinary sense and describes a material that can be both dissolved in and biologically assimilated by a patient.

The term “sealant”, as in “tissue sealant”, refers to compositions that become anchored in place by mechanical and/or chemical means to seal tissues together that have become separated as the result of various disease states or surgical procedures. For example, sealants can be used to fill voids in hard tissues, to join vascular and other soft tissues together, to provide a mechanical barrier to promote hemostasis, and to prevent tissue adhesions by keeping one tissue surface from coming in contact with and becoming adhered to another tissue surface. Depending on the context, a sealant may serve as an adhesive or an adhesion inhibitor.

The term “synthetic” as in “synthetic compound” as used herein refers to a manmade compound, which is typically highly pure or is purified to a highly pure state such that the compound is, or is treated to become, pharmaceutically pure.

The term “substantially” as in, for example, the phrase “substantially the same flow rate,” refers flow rates that differ from each other by no more than about 10%, preferably by no more than 5%, more preferably by no more than 1%, and most preferably by no more than 0.5%. Other uses of the term “substantially” involve an analogous definition.

In general, the invention relates to devices and methods for dispensing a multicomponent composition comprised of a mixture of a plurality of different fluid components. A diffuser surface having an outlet extending therethrough is positioned downstream from a plurality of inlets. While at least one inlet is adapted to communicate with a source of a pressurized carrier fluid, each of a plurality of inlets is adapted to communicate with a source of a different fluid component. Once the diffuser surface receives fluid components from the inlets, each received fluid component is toward the outlet for mixing and dispensing therethrough by the pressurized carrier fluid, typically a gas such as air, from the carrier fluid inlet. The diffuser surface and the inlets may represent components of a mixing nozzle.

In general, there are two categories of gas-enhanced nozzles dispensing reactive components of a multicomponent composition—those that involve internal mixing and those that involve external mixing. When the diffuser surface is a part of a nozzle, the inventive device may be considered an internal-mixing nozzle. Unlike other internal-mixing technologies, the invention provides several features that serve individually and collectively to eliminate clogging. For example, diffuser surface typically has a shape effective to direct and maintain each received fluid component in a different flow path on the diffuser surface toward the outlet for mixing therein and dispensing therethrough. Due to the minimal residence time of the mixture within the nozzle, reactive components do not have time to set and clog the nozzle before the mixture is force out of the nozzle by the pressurized carrier fluid. In addition, the outlet may be aligned with any or all of the carrier fluid inlets that may be present in the nozzle to direct the pressurized carrier fluid in a manner that enhances fluid component mixing and to expel the mixture in a jet like manner. As the orientation of the diffuser surface relative to the inlets affects the performance of the device, the diffuser surface may be permanently affixed or immobilized with respect to the inlets. However, when the diffuser surface is detachable from the inlets, the nozzle may be disassembled to facilitate cleaning and/or replacement of parts. For example, the diffuser surface may be replaceable/and or disposable. Nevertheless, when the device has diffuser surface that is detachable from the inlets, the device may be constructed to allow assembly of its components in only configurations that align the diffuser surface to the inlets such that the performance of the device is optimized.

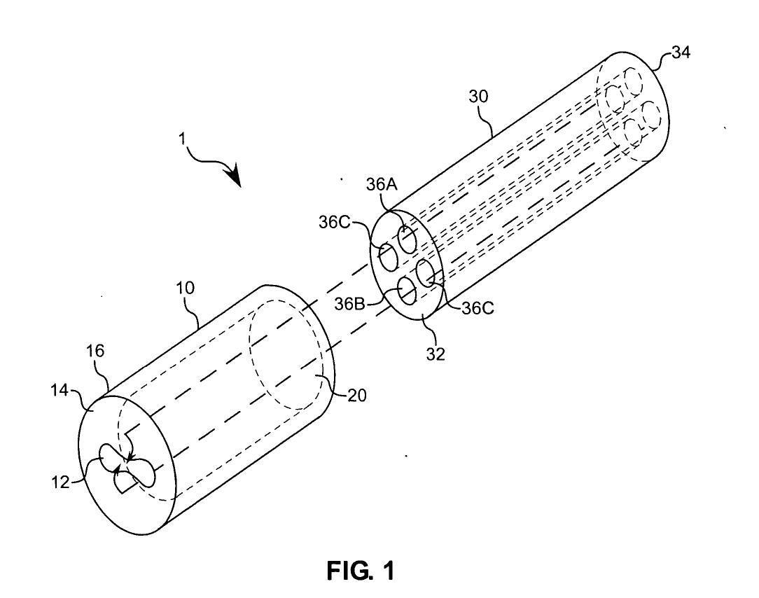

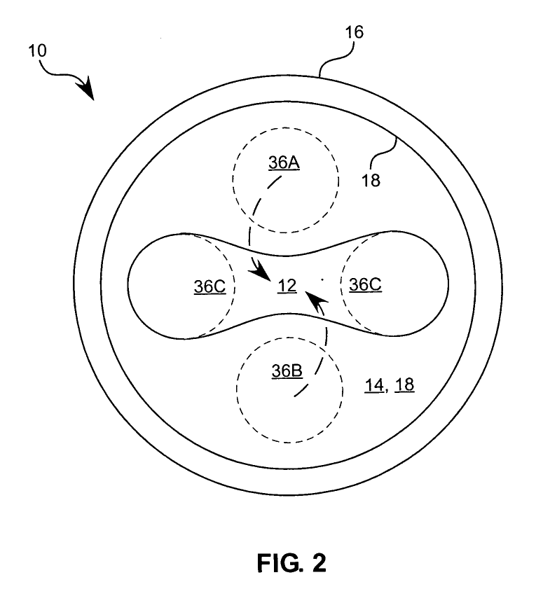

Thus, FIGS. 1 and 2 illustrate an example of the inventive device in the form of a nozzle that includes all of the above-discussed features which serve eliminate the problems associated with nozzle clogging. FIGS. 1 and 2 are not necessarily to scale, and certain dimensions may be exaggerated for clarity of presentation. As depicted in FIG. 1, the nozzle 1 includes a cap 10 having a slot-shaped outlet orifice 12 extending through the center of end 14. The cap 10 is shown as having a cylindrical exterior surface 16 and an interior surface 18 that terminates at opening 20, but additional cap shapes are also suitable for use with the invention. The interior surface 18 of the cap 10 at end 14 serves to receive fluid components thereon.

Also provided is a generally elongate cylindrical connector 30 in the form of a unitary member having a first terminus 32 and a second terminus 34. A plurality of inlet lumens 36A, 36B, and 36C traversing the length of the connector defined by termini 32 and 34. As depicted, the connector 30 is detached from the cap 30. Inlet lumens 36A and 36B are each provided fluid communication at the second terminus 34 with a different source of a fluid component (not shown). Similarly, inlet lumens 36C are provided fluid communication at the second terminus 34 with a source of pressurized carrier gas (not shown). The carrier fluid inlet lumens 36C define a plane that is perpendicular to a plane defined by the fluid component inlet lumens 36A and 36B. As depicted, the first terminus 32 of the connector 30 has dimensions suitable for forming a fluid-tight seal against the interior surface 18 of the cap 10 at its proximal opening 20.

In operation, the cap 10 is placed over the first terminus 32 of the connector 30 such that the carrier fluid inlet lumens 36C are aligned with outlet orifice 12. In addition, each of a plurality of different fluid component sources is provided fluid communication with the fluid component inlet lumens 36A and 36B and at least one source of pressurized carrier gas is provided fluid communication with the carrier fluid inlet 36C.

As discussed above, the interior surface 18 of the cap 10 at end 14 serves as a diffuser surface that is adapted to receive fluid components thereon. As depicted in FIG. 2, the diffuser surface exhibits two-fold axial symmetry. The dotted lines indicate the position of lumens 36A, 36B, and 36C relative to the diffuser surface. Similarly, the dashed lines 38A and 38B indicate the separate flow path of the fluid components emerging from the fluid component inlet lumens 36A and 36B, respectively, and directed by the diffuser surface in a generally inward direction toward the center outlet orifice 12. Once the fluid components reach outlet orifice 12, pressurized gas from carrier fluid lumens 36C mixed the fluid component and forced the mixture out of the outlet orifice 12.

In the inventive device, the geometries of and spatial relationships between the various components of diffuser surface represent an important aspect of the invention. For example, the invention may be used to carry out mixing of a plurality of reactive components. Typically, nozzles for mixing reactive components are of the external mixing category because previously known internal mixing designs are prone to clogging. Clogging result when reactive components are mixed prior to introduction to the gas stream. In contrast, the invention provides a high-pressure area between the inlets and the diffuser surface that serves to mix reactive fluids while simultaneously forcing the mixture out of the orifice.

In addition, the diffuser surface is located downstream from the inlets and is effective to direct fluid components toward the outlet for mixing and dispensing therethrough by a pressurized carrier fluid. Thus, the diffuser surface should exhibit an appropriate shape to carry out its desired function while minimizing the odds of device clogging. For example, while the diffuser surface depicted in FIGS. 1 and 2 is located within a cylindrical cap having a flat exterior circular end surface and contains a centrally located slot-shaped orifice, such geometry is not required. As depicted in the figures, the exterior surface of the cap is generally parallel to the diffuser surface. While both FIGS. 1 and 2 depict caps that exhibit axially symmetry, symmetry, axial, mirror, or otherwise, is merely preferred and not required. Thus, it is expected that variations on diffuser surface shapes and nozzle configurations may be developed through routine experimentation.

With respect to the inlets, the inventive device generally requires a plurality of fluid component inlets for communication with an equal or less number of sources of fluid components. While a single carrier fluid inlet may be provided, the inventive device typically provides a plurality of carrier fluid inlets. Often the carrier fluid inlets are provided communication with a single source of carrier fluid via a splitter or manifold, though a plurality of carrier fluid sources may be advantageously used as well in certain instances.

In addition, inlets are typically each located at the terminus of a corresponding lumen. In some instances, the lumens may coextend through a unitary tubing member, as depicted in FIGS. 1 and 2. Alternatively, the lumens may extend through separate tubes. Furthermore, tubes and/or tubing members may be constructed to form a lumen assembly. For example, various lengths of multilumen delivery tubing for use in specific surgical or non-surgical applications. Particularly in laparoscopic applications, it may be useful to employ flexible tubing. The tubing serves to maintain separation of the two fluid components and provide a pathway for the delivery of pressurized gas to the diffuser surface.

Additional features also serve to enhance the mixing and delivery performance of the invention. As discussed above, two or more fluid components may be individually delivered through inlets to impinge upon the diffuser surface. Typically, the components first impinge upon the diffuser plate near the outlet to reduce the residence time of the components in the device. Any of a number of means may be used to provide motive force to introduce fluid components through the inlets and toward the outlet. Exemplary motive force means include pumps, compressors, pistons, and the like.

Then, as the diffuser plate directs the components toward the outlet, and the pressurized carrier fluid simultaneously provides a force to mix and expel the components through the outlet. Accordingly, one or more the carrier fluid inlets are positioned such that a high-pressure zone is created between the component inlets and the diffuser surface while a comparatively low-pressure zone is created downstream from the outlet. “Dead space” that serve to trap residue is generally avoided. As a result, a fluid mixture is forced through the outlet in a jet-like fashion, thereby reducing any potential or actual buildup of residue that serve to clog the inventive device.

In general, any of a number of carrier fluids may be employed with the invention. For example, the carrier fluid may be gaseous and/or liquid in nature. Typically, however, the carrier fluid is chemically inert with respect to the fluid components. Suitable inert gases include, without limitation, air, carbon dioxide, nitrogen, argon, helium, gaseous perfluorinated alkanes and ethers, gaseous chlorofluorocarbons and the like. Suitable inert liquids include, without limitation, polysiloxanes, perfluroinated polyethers, and the like. Pressurized air represents an economical and practical carrier fluid for use with the invention. Equipment associated with pressurized air is well known in the art and may include pressurized tanks or cylinders as well as compressors. In some instances, one or more check valves, e.g., one-way valves, may be provided to prevent back flow of fluid component resulting from pressure buildup associated with the use of the inventive device. Such check valves may be positioned upstream from the diffuser surface, e.g., within lumens associated with the inlets. Such check valves are particularly useful when inlet lumens are short, e.g., about 2 to about 5 centimeters in length, because the potential for back flow tends to be inversely proportional to the length of the lumens. However, check valves may be employed with longer lumens as well.

The portions of the device that contact multicomponent composition and the fluid components thereof should be inert and preferably repellant to the materials contacted. Thus, portions of the device that contact the fluids in operation should be selected according to the fluids themselves. For example, the device or components thereof may be made from a plastic such as polycarbonates, polyurethane, polyesters, acrylics, ABS polymers, polysulfone, and the like. Adhesion inhibiting coatings such as polysiloxanes, perfluorinated polymers, and the like may be used as well. Thus, the diffuser surface is typically inert and optionally repelling to the fluid components. Similar, lumen surfaces that may contact the fluid components or the carrier fluid are typically inert and optionally repelling to the corresponding fluid as well.

The invention is particularly useful for dispensing multicomponent compositions. While some gaseous components may be used, the invention is particularly useful for liquids. Thus, at least one fluid component is usually a liquid. Often, each fluid component includes a liquid. For example, the invention is useful to dispense composition such as fluid mixtures, wherein the mixing of a plurality of fluids results in an increase in viscosity sufficient to impair mixture flow. Such compositions may be formed from fluid components that are chemically reactive with respect to each other. In some instances, a crosslinking agent may be provided.

In practice, then, a diffuser surface having an outlet extending therethrough such that the diffuser surface is downstream from a plurality of fluid component inlets and at least one carrier fluid inlet. A different fluid component is directed from each of the fluid component inlets toward the diffuser surface. In some instances, fluid components are directed at substantially the same flow rate toward the diffuser surface. Alternatively, the fluid components are directed at different flow rates toward the diffuser surface. Typically, the flow rate of the carrier fluid is higher than that for the fluid components. The diffuser surface maintains and directs each received fluid component in a different flow path toward the outlet. Pressurized carrier fluid from the at least one carrier fluid inlet is also directed through the outlet, thereby mixing the fluid components present at the outlet and dispensing the composition through the outlet.

For laparoscopic procedures, the multicomponent composition is typically polymeric in nature, and certain classes of compounds may be particularly preferred to form the polymer composition. For example, synthetic polymers such as poly(acrylic acid), poly(vinyl alcohol), poly(acrylamide), poly(N-isopropylacrylamide), poly(methacrylate), poly(hydroxyethylmethacrylate), poly(vinyl acetate), copolymers and derivatives of these materials may be formed using the invention. However, biocompatible synthetic polymers are preferred for laparoscopic procedures. In addition or in the alternative, naturally occurring compounds such as proteins and saccharides may be used as well. It is well known in the art that such compounds may be used to form sealants that serve as biocompatible adhesive and/or adhesion inhibitors.

Polyethylene glycol (PEG) containing compounds are well known for their biocompatibility. Various forms of PEG are extensively used in the modification of biologically active molecules because PEG can be formulated to have a wide range of solubilities and because it is low in toxicity, antigenicity, immunogenicity, and does not typically interfere with the enzymatic activities and/or conformations of peptides. Further, PEG monomers are generally non-biodegradable and are easily excreted from most living organisms, including humans.

Suitable PEGs include mono-, di-, and multifunctional PEG. Monofunctional PEG has only one reactive hydroxy group, while difunctional PEG has reactive groups at each end. Monofunctional PEG preferably has an average molecular weight between about 100 and about 15,000 daltons, more preferably between about 200 and about 8,000, and most preferably about 4,000. Difunctional and multifunctional PEG preferably have a molecular weight of about 400 to about 100,000, more preferably about 3,000 to about 20,000.

Those of ordinary skill in the art will appreciate that synthetic polymers such as PEG are not currently prepared practically to have exact molecular weights, and that the term “molecular weight” as used herein refers to an average molecular weight of a number of molecules in any given sample, as commonly used in the art. Thus, a sample of PEG 2,000 might contain a statistical mixture of polymer molecules ranging in weight from, for example, 1,500 to 2,500 daltons, with one molecule differing slightly from the next over a range. Specification of a range of molecular weight indicates that the average molecular weight may be any value between the limits specified, and may include molecules outside those limits. Thus, a molecular weight range of about 800 to about 20,000 indicates an average molecular weight of at least about 800, ranging up to about 20 kDa.

PEG can be rendered monofunctional by forming an alkylene ether at one end. The alkylene ether may be any suitable alkoxy radical having 1-6 carbon atoms, for example, methoxy, ethoxy, propoxy, 2-propoxy, butoxy, hexyloxy, and the like. Methoxy is presently preferred. Difunctional PEG is provided by allowing a reactive hydroxy group to exist at each end of the linear molecule. The reactive groups are preferably at the ends of the polymer, but may be provided along the length thereof. Polyfunctional molecules are capable of crosslinking the compositions of the invention, and may be used to attach additional moieties.

In some instances, naturally occurring compounds may be employed. Suitable naturally occurring compounds include, but are not limited to: polysaccharides such as hyaluronic acid, cyclodextrin, hydroxymethylcellulose, cellulose ether, and starch; glycans such glycosaminoglycan and proteoglycan; and various proteins. Proteins such as collagen and other collagenic materials are particularly suited for use in the present invention.

The invention may be advantageously used to form compositions containing collagen as well. It is known in the art that collagen is the major protein component of bone, cartilage, skin, and connective tissue in animals. Collagen, in its native form, is typically a rigid, rod-shaped molecule approximately 300 nm long and 1.5 nm in diameter. It is composed of three collagen polypeptides, which together form a tight triple helix. The collagen polypeptides are each characterized by a long midsection having the repeating sequence -Gly-X—Y—, where X and Y are often proline or hydroxyproline, bounded at each end by the “telopeptide” regions, which constitute less than about 5% of the molecule. The telopeptide regions of the collagen chains are typically responsible for the crosslinking between chains, and for the immunogenicity of the protein. Collagen occurs in several types, having distinct physical properties. The most abundant types are Types I, II and III. Further, collagen is typically isolated from natural sources, such as bovine hide, cartilage, or bones. Bones are usually dried, defatted, crushed, and demineralized to extract collagen, while hide and cartilage are usually minced and digested with proteolytic enzymes (other than collagenase). As collagen is resistant to most proteolytic enzymes, this procedure conveniently serves to remove most of the contaminating protein found with collagen.

Suitable collagenic materials include all types of pharmaceutically useful collagen, preferably types I, II, and III. Collagens may be soluble (for example, commercially available VITROGEN® 100 collagen-in-solution), and may or may not have the telopeptide regions. Preferably, the collagen will be reconstituted fibrillar atelopeptide collagen, for example ZYDERM® collagen implant (ZCI) or atelopeptide collagen in solution (CIS). Optionally, colony stimulating factors (CSFs) may be included as well. Various forms of collagen are available commercially, or may be prepared by the processes described in, for example, U.S. Pat. Nos. 3,949,073, 4,488,911, 4,424,208, 4,582,640, 4,642,117, 4,557,764, and 4,689,399. In addition, other forms of collagen are also useful in the practice of the invention, and are not excluded from consideration here. For example, non-fibrillar collagens such as methylated or succinylated collagens may be employed in the present invention. In some instances, collagen crosslinked using heat, radiation, or chemical agents such as glutaraldehyde may be employed. Similarly, gelatin, i.e., collagen denatured typically through boiling, may be suitable.

In some instances, conjugates of the aforementioned materials may be formed. For example, collagenic material may be chemically bound to another polymer, e.g., a synthetic hydrophilic polymer, to form a conjugate. Such collagen-containing conjugates are known in the art and are described, for example, in U.S. Pat. Nos. 5,264,214, 5,304,595, 5,306,500, 5,376,375, 5,413,791, 5,523,348, 5,446,091, 5,543,441, 5,550,188, 5,162,430, 5,328,955, 5,324,775, 5,308,889, 5,292,802, 5,510,418, 5,565,519, 5,470,911, and 5,476,666.

The chemical binding can be carried out in a variety of ways. In accordance with the preferred method, the synthetic hydrophilic polymer is activated and then reacted with the collagen. Alternatively, the hydroxyl or amino groups present on the collagen can be activated, and the activated groups reacted with the polymer to form the conjugate. In accordance with a less preferred method, a linking group with activated hydroxyl or amino groups thereon can be combined with the polymer and collagen in a manner so that it will concurrently react with both the polymer and collagen, forming the conjugate. Since the sealants described herein may be used in the human body, it is important that all of the components of the conjugate, e.g., polymer, collagen, and linking group, singly and in combination, are unlikely to be rejected by the body. Accordingly, toxic and/or immunoreactive components are not preferred as starting materials.

For example, the first step in forming the collagen-polymer conjugates often involves the functionalization of the polymer molecule. Various functionalized PEGs have been used effectively in fields such as protein modification (see Abuchowski et al., Enzymes as Drugs, John Wiley & Sons: New York, N.Y. (1981) pp. 367-383; and Dreborg et al., Crit. Rev. Therap. Drug Carrier Syst. (1990) 6:315, both of which are incorporated herein by reference), peptide chemistry (see Mutter et al., The Peptides, Academic: New York, N.Y. 2:285-332; and Zalipsky et al., Int. J. Peptide Protein Res. (1987) 30:740, both of which are incorporated herein by reference), and the synthesis of polymeric drugs (see Zalipsky et al., Eur. Polym. J. (1983) 19:1177; and Ouchi et al., J. Macromol. Sci. -Chem. (1987) A24:1011. Various types of conjugates formed by the binding of PEG with specific, pharmaceutically active proteins have been disclosed and found to have useful medical applications, in part due to the stability of such conjugates with respect to proteolytic digestion, reduced immunogenicity, and longer half-lives within living organisms.

One form of PEG that has been found to be particularly useful is monomethoxypolyethylene glycol (mPEG), which can be activated by the addition of a compound such as cyanuric chloride, then coupled to a protein (see Abuchowski et al., J. Biol. Chem. (1977) 252:3578, which is incorporated herein by reference). Although such methods of activating PEG can be used in connection with the present invention, they are not particularly desirable in that the cyanuric chloride is relatively toxic and must be completely removed from any resulting product in order to provide a pharmaceutically acceptable composition.

Activated forms of PEG can be made from reactants that can be purchased commercially. One form of activated PEG, which has been found to be particularly useful in connection with the present invention, is mPEG-succinate-N-hydroxysuccinimide ester (SS-PEG) (see Abuchowski et al., Cancer Biochem. Biphys. (1984) 7:175, which is incorporated herein by reference). Activated forms of PEG such as SS-PEG react with the proteins under relatively mild conditions and produce conjugates without destroying the specific biological activity and specificity of the protein attached to the PEG. However, when such activated PEGs are reacted with proteins, they react and form linkages by means of ester bonds. Although ester linkages can be used in connection with the present invention, they are not particularly preferred in that they undergo hydrolysis when subjected to physiological conditions over extended periods of time (see Dreborg et al., Crit. Rev. Therap. Drug Carrier Syst. (1990) 6:315; and Ulbrich et al., J. Makromol. Chem. (1986) 187:1131, both of which are incorporated herein by reference).

It is possible to link PEG to proteins via urethane linkages, thereby providing a more stable attachment that is more resistant to hydrolytic digestion than the ester linkages (see Zalipsky et al., Polymeric Drug and Drug Delivery Systems, Chapter 10, “Succinimidyl Carbonates of Polyethylene Glycol” (1991) incorporated herein by reference to disclose the chemistry involved in linking various forms of PEG to specific biologically active proteins). The stability of urethane linkages has been demonstrated under physiological conditions (see Veronese et al., Appl. Biochem. Biotechnol. (1985) 11:141; and Larwood et al., J. Labelled Compounds Radiopharm. (1984) 21:603, both of which are incorporated herein by reference). Another means of attaching the PEG to a protein can be by means of a carbamate linkage (see Beauchamp et al., Anal. Biochem. (1983) 131:25; and Berger et al., Blood (1988) 71:1641, both of which are incorporated herein by reference). The carbamate linkage is created by the use of carbonyldiimidazole-activated PEG. Although such linkages have advantages, the reactions are relatively slow and may take 2 to 3 days to complete.

The conjugates formed using the functionalized forms of PEG vary depending on the functionalized form of PEG that is used in the reaction. Furthermore, the final product can be modified with respect to its characteristics by changing the molecular weight of the PEG. In general, the stability of the conjugate is improved by eliminating any ester linkages between the PEG and the collagen, and including ether and/or urethane linkages. However, to promote resorption, weaker ester linkages may be included so that the linkages are gradually broken by hydrolysis under physiological conditions. That is, by varying the chemical structure of the linkage, the rate of resorption can be varied.

Polyfunctional polymers may also be used to crosslink collagen molecules to other proteins (e.g., glycosaminoglycans, chondroitin sulfates, fibronectin, and the like), particularly growth factors, for compositions particularly suited for use in wound healing, osteogenesis, and immune modulation. Such tethering of cytokines to collagen molecules provides an effective slow-release drug delivery system.

Collagen contains a number of available amino and hydroxy groups that may be used to bind the synthetic hydrophilic polymer. The polymer may be bound using a “linking group”, as the native hydroxy or amino groups that are present in collagen and in the polymer frequently require activation before they can be linked. For example, one may employ compounds such as dicarboxylic anhydrides (e.g., glutaric or succinic anhydride) to form a polymer derivative (e.g., succinate), which may then be activated by esterification with a convenient leaving group, for example, N-hydroxysuccinimide, N,N′-disuccinimidyl oxalate, N,N′-disuccinimidyl carbonate, and the like. See also Davis, U.S. Pat. No. 4,179,337, for additional linking groups. Presently preferred dicarboxylic anhydrides that are used to form polymer-glutarate compositions include glutaric anhydride, adipic anhydride, 1,8-naphthalene dicarboxylic anhydride, and 1,4,5,8-naphthalenetetracarboxylic dianhydride. The polymer thus activated is then allowed to react with the collagen, forming a collagen-polymer composition used to make the tubes.

For example, a pharmaceutically pure form of monomethylpolyethylene glycol (mPEG) (MW 5,000) may be reacted with glutaric anhydride (pure form) to create mPEG glutarate. The glutarate derivative is then reacted with N-hydroxysuccinimide to form a succinimidyl monomethylpolyethylene glycol glutarate. The succinimidyl ester (mPEG*, denoting the activated PEG intermediate) is then capable of reacting with free amino groups present on collagen (lysine residues) to form a collagen-PEG conjugate wherein one end of the PEG molecule is free or nonbound. Other polymers may be substituted for the monomethyl PEG, as described above. Similarly, the coupling reaction may be carried out using any known method for derivatizing proteins and synthetic polymers. The number of available lysines conjugated may vary from a single residue to 100% of the lysines, preferably 10-50%, and more preferably 20-30%. The number of reactive lysine residues may be determined by standard methods, for example by reaction with TNBS.

A number of sealants may be formed using through the practice of the inventive method. In situ hydrogel forming compositions are known in the art and can be administered as liquids from a variety of different devices. One such composition provides a photoactivatable mixture of water-soluble copolyester prepolymers and polyethylene glycol. Another such composition employs block copolymers of Pluronic and Poloxamer that are soluble in cold water, but form insoluble hydrogels that adhere to tissues at body temperature (Leach, et al., Am. J. Obstet. Gynecol. 162:1317-1319 (1990)). Polymerizable cyanoacrylates have also been described for use as tissue adhesives (Ellis, et al., J. Otolaryngol. 19:68-72 (1990)). WO 97/22371 describes two-part synthetic polymer compositions that, when mixed together, form covalent bonds with one another, as well as with exposed tissue surfaces. Similarly, U.S. Pat. No. 5,583,114 describes a two-part composition that is a mixture of protein and a bifunctional crosslinking agent has been described for use as a tissue adhesive.

The invention may also be used to prepare and dispense a coagulum-based wound sealant, e.g. a fibrin glue. Such wound sealants may be prepared by mixing a procoagulant-containing solution (which contains fibrinogen) with a solution comprising a fibrinogen activator. Suitable fibrinogen-containing solutions are typically obtained from plasma separated from anticoagulated whole blood by density difference fractionation (e.g., by gravity or centrifugation). Fibrinogen activators are well known and include thrombin and batroxobin, both of which are commercially available. In addition, a variety of additional components can be added to the fibrinogen or fibrinogen activator solutions to modify the characteristics of the coagulum. For example, antifibrinolytics can be employed to regulate the time required for the body to break down the coagulum. Platelets can be included in the fibrinogen solution to increase coagulum strength and adhesion, augment hemostasis, and improve healing. Additionally, calcium can be added to the fibrinogen activator solution to accelerate fibrin crosslinking and stability. Ground bone, demineralized bone matrix, hydroxyapatite, or the like can be included in the fibrinogen activator solution to promote bone regrowth.

Thus, optional additives can be incorporated into the multicomponent composition. For example, an elasticizer such as glycerol may be added to composition to deformability of composition. Similarly, pharmacologically active agents, e.g., organic molecules which exert biological effects in vivo, may be included the composition. Examples of active agents include, without limitation, enzymes, receptor antagonists or agonists, hormones, growth factors, antibiotics, antimicrobial agents, and antibodies.

Variations of the present invention will be apparent to one of ordinary skill in the art. For example, while particular attention has been given multicomponent compositions that contain PEG-collagen conjugates, other conjugates, such as PEG-PEG and collagen-collagen, may be employed as well. Similarly, while the outlet orifice has been described as having a slotted shape, other outlet orifice shapes may be advantageously used as well. Exemplary orifice shapes include, circles, ovals, triangles, rectangles, squares, diamonds, pentagons, etc.

It is to be understood that, while the invention has been described in conjunction with the preferred specific embodiments thereof, the foregoing description is intended to illustrate and not limit the scope of the invention. Other aspects, advantages, and modifications within the scope of the invention will be apparent to those skilled in the art to which the invention pertains.

We claim:

1. A device for dispensing a multicomponent composition comprised of a mixture of a plurality of different fluid components, the device comprising:
a plurality of fluid component inlets, each adapted to communicate with a source of a different fluid component;
at least one carrier fluid inlet adapted to communicate with a source of a pressurized carrier fluid;
a diffuser surface located downstream from the plurality of fluid component inlets and the at least one carrier fluid inlet; and
an outlet extending through the diffuser surface,
wherein the diffuser surface is adapted to receive fluid components thereon, and has a shape effective to direct and maintain each received fluid component in a different flow path toward the outlet for mixing and dispensing therethrough by the pressurized carrier fluid from the at least one carrier fluid inlet.

2. The device of claim 1, wherein the outlet is aligned with the at least one carrier fluid inlet.

3. The device of claim 1, wherein the outlet is a slot shaped orifice.

4. The device of claim 1, wherein the outlet is located at the center of the diffuser surface.

5. The device of claim 1, wherein the diffuser surface is permanently immobilized to the inlets.

6. The device of claim 1, wherein the diffuser surface exhibits axial and/or mirror symmetry.

7. The device of claim 1, wherein the inlets are each located at the terminus of a corresponding lumen.

8. The device of claim 7, wherein the lumens coextend through a tubing member.

9. The device of claim 1, comprising a plurality of carrier fluid inlets adapted to communicate with a source of pressurized carrier fluid.

10. The device of claim 9, wherein the carrier fluid inlets define a line that is perpendicular to a line defined by the fluid component inlets.

11. The device of claim 1, further comprising
a plurality of different fluid component sources each in communication with a different fluid component inlet, and
a source of pressurized carrier fluid in communication with the carrier fluid inlet.

12. The device of claim 11, wherein at least one component fluid inlet is formed from a material not prone to adhesion with any fluid component and/or the multicomponent composition.

13. The device of claim 11, wherein at least one fluid component is a liquid.

14. The device of claim 11, wherein the fluid components are chemically reactive with respect to each other.

15. The device of claim 14, wherein at least one fluid component is comprised of a crosslinking agent.

16. The device of claim 14, wherein at least one fluid component is comprised of a synthetic compound

17. The device of claim 16, wherein the synthetic compound is a polyethylene glycol-containing compound.

18. The device of claim 14, wherein at least one fluid component is comprised of a naturally occurring compound.

19. The device of claim 18, wherein the naturally occurring compound is a protein.

20. The device of claim 19, wherein the protein is a collagenic material.

21. The device of claim 19, wherein the naturally occurring compound is a saccharide.

22. The device of claim 11, wherein at least one fluid component is biocompatible.

23. The device of claim 11, wherein the pressurized carrier fluid is a gas.

24. The device of claim 11, wherein the carrier fluid is chemically inert with respect to the fluid components.

25. A method for forming a device for dispensing a multicomponent composition comprised of a mixture of a plurality of different fluid components, the method comprising
placing a diffuser surface having an outlet extending therethrough such that the diffuser surface is downstream from a plurality of fluid component inlets and at least one carrier fluid inlet,
wherein the diffuser surface is adapted to receive fluid components thereon, and has a shape effective to maintain and direct each received fluid component in a different flow path toward the outlet.

26. A method for dispensing a multicomponent composition comprised of a mixture of a plurality of different fluid components, the method comprising:
(a) carrying out the method of claim 25;
(b) directing a different fluid component from each of the fluid component inlets toward the diffuser surface;
(c) allowing the diffuser surface to maintain and direct each received fluid component in a different flow path toward the outlet; and
(d) directing pressurized carrier fluid from the at least one carrier fluid inlet through the outlet, thereby mixing the fluid components present at the outlet and dispensing the composition through the outlet.

27. The method of claim 26, wherein the fluid components are directed at substantially the same flow rate toward the diffuser surface during step (b).

28. The method of claim 26, wherein the fluid components are directed at different flow rates toward the diffuser surface during step (b).

29. The method of claim 26, wherein the composition formed comprised of a polymer.

30. The method of claim 29, wherein the polymer is crosslinked.

31. The method of claim 29, wherein the polymer is conjugated.

32. The method of claim 29, wherein the polymer is resorbable.

33. The method of claim 29, wherein the polymer serves as a sealant.

34. The method of claim 29, wherein the polymer serves as a biocompatible adhesive.

35. The method of claim 29, wherein the polymer serves as a biocompatible adhesion inhibitor.

36. A device for dispensing a multicomponent composition comprised of a mixture of a plurality of different fluid components, the device comprising:
a plurality of fluid component inlets, each adapted to communicate with a source of fluid component;
a plurality of carrier fluid inlets adapted to communicate with a source of a pressurized carrier fluid;
a diffuser surface located downstream from the plurality of fluid component inlets and the plurality of carrier fluid inlets; and
an outlet extending through the diffuser surface and aligned with the plurality of carrier fluid inlets,
wherein the diffuser surface is adapted to receive fluid components thereon, and has a shape effective to direct each received fluid component toward the outlet for mixing and dispensing therethrough by pressurized carrier fluid from the plurality of carrier fluid inlets.

37. A method for forming a device for dispensing a multicomponent composition comprised of a mixture of a plurality of different fluid components, the method comprising
placing a diffuser surface having an outlet extending therethrough such that the diffuser surface is downstream from a plurality of fluid component inlets and a plurality of carrier fluid inlets, and the outlet is aligned with the plurality of carrier fluid inlets,
wherein the diffuser surface is adapted to receive fluid components thereon, and has a shape effective to maintain and direct each received fluid component toward the outlet.

38. A method for dispensing a multicomponent composition comprised of a mixture of a plurality of different fluid components, the method comprising:
(a) carrying out the method of claim 37;
(b) directing a different fluid component from each of the fluid component inlets toward the diffuser surface;
(c) allowing the diffuser surface to direct each received fluid component toward the outlet; and
(d) directing pressurized carrier fluid from the at least one carrier fluid inlet through the outlet, thereby mixing the fluid components present at the outlet and dispensing the composition through the outlet.
